(19) United States
(12) Patent Application Publication
(10) Pub. No.: US 2006/0031224 A1
(43) Pub. Date: Feb. 9, 2006

(54) Method, system and computer program product for managing database records with attributes located in multiple databases

(75) Inventors: Julianne Frances Haugh, Austin, TX (US); Ufuk Celikkan, Austin, TX (US); Yantian Lu, Round Rock, TX (US)

Correspondence Address: DILLON & YUDELL LLP, Suite 2110, 8911 North Capital of Texas Highway, Austin, TX, 78759, US

(73) Assignee: International Business Machines Corp., Armonk, NY (US)

(21) Appl. No.: 10/912,494

(22) Filed: Aug. 5, 2004

(51) Int. Cl. G06F 17/30

(52) U.S. Cl. 707/10

(57) ABSTRACT

A method, system, and computer program product for managing database records with attributes located in multiple registries are disclosed. A data processing system identifies one or more attributes of a record to be accessed from one or more of a plurality of distributed databases, wherein a first attribute among the one or more attributes resides in an unknown database among the plurality of databases and it is known that a second attribute resides in a particular database among the plurality of databases. The data processing system forms a query, which includes a request for the first attribute and a request for the second attribute, and sends the query to the particular database. The data processing system receives a positive response to the query indicating that the particular database contains the first attribute for the record, and in response to receiving the positive response, the data processing system stores an identifier of the particular database in association with the first attribute. The data processing system then accesses the first attribute and the second attribute of the record in the particular database.

### BACKGROUND OF THE INVENTION

1. Technical Field

The present invention relates in general to data processing and in particular to improving efficiency of data access, distribution and modification within a distributed database. Still more particularly, the present invention relates to a system, method and computer program product for accessing, distributing and/or modifying a record in a database that is distributed across multiple data processing systems connected to a network.

2. Description of the Related Art

The profusion of distributed database applications, wherein portions of a database, and even portions of individual records, are scattered on different data processing systems, which exchange data across networks, now enables a range of technologies inconceivable only a few years ago. Applications relying on distributed databases of the type described above range from simple network login schemes to sophisticated financial services databases for performing bank transactions.

Conventionally, distributed database systems define and store records, such as user IDs, user groups and other information in a variety of different locations and storage systems related to specific functions. The existing standards-based information storage and retrieval methods (e.g. Distributed Computing Environment (DCE), Lightweight Directory Access Protocol (LDAP), Network Information System (NIS+) and others) were designed to serve disparate purposes.

DCE, for example, provides a software technology for configuring and managing computing and data exchange on a client/server model in a system of distributed computers, which is typically used in a larger network of computing systems that include different size servers scattered geographically. Using DCE, application users can use applications and data at remote servers, and application programmers need not be aware of where their programs will run or where the data will be located.

NIS+, by contrast, includes a naming and administration system for smaller networks that also provides security facilities. Using NIS+, each host, client or server computer in the system has knowledge about the entire system. A user at any host can get access to files or applications on any host in the network with a single user identification and password. NIS+ is similar to the Internet's domain name system but somewhat simpler and designed for a smaller network. It is intended for client/server use on local area networks through the operation of the Remote Procedure Call interface. NIS+ consists of a server, a library of client programs, and some administrative tools, which are often used with the Network File System.

LDAP is a software protocol for enabling a client or user to access organizations, individual user records, and other resources such as files and devices in a network, whether on the public Internet or on a corporate Intranet. LDAP allows a user to search for an individual record without knowing where it is located.

As can be foreseen from the description of each of the protocols listed above, the emphasis on location-independence has meant that none of the storage and retrieval methods listed above readily allow an application to determine the location of information. Further, because of the different purposes driving the designs of the protocols listed above, each protocol provides its own administrative tools and requires administrators and application designers to learn those tools.

There is no existing mechanism for managing user and group account information from multiple simultaneous sources across these varying protocols and applications. The increasing need for systems to interact transparently with databases distributed across multiple physical storage locations has created an increasing need for location-independent interoperability. What is needed is a way to enable applications interacting with database records, which are distributed across several storage locations, to know the location of attributes of the records.

### SUMMARY OF THE INVENTION

A method, system, and computer program product for managing database records with attributes located in multiple registries are disclosed. A data processing system identifies one or more attributes of a record to be accessed from one or more of a plurality of distributed databases, wherein a first attribute among the one or more attributes resides in an unknown database among the plurality of databases and it is known that a second attribute resides in a particular database among the plurality of databases. The data processing system forms a query, which includes a request for the first attribute and a request for the second attribute, and sends the query to the particular database. The data processing system receives a positive response to the query indicating that the particular database contains the first attribute for the record, and in response to receiving the positive response, the data processing system stores an identifier of the particular database in association with the first attribute. The data processing system then accesses the first attribute and the second attribute of the record in the particular database.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 illustrates a distributed database in a network environment, in which preferred embodiments of the method, system and computer program product for managing database records with attributes located in multiple registries is implemented; and

FIG. 2 is a high-level logical flowchart of a process for managing database records with attributes located in multiple registries in accordance with a preferred embodiment of the present invention.

### DETAILED DESCRIPTION OF THE PREFERRED EMBODIMENT

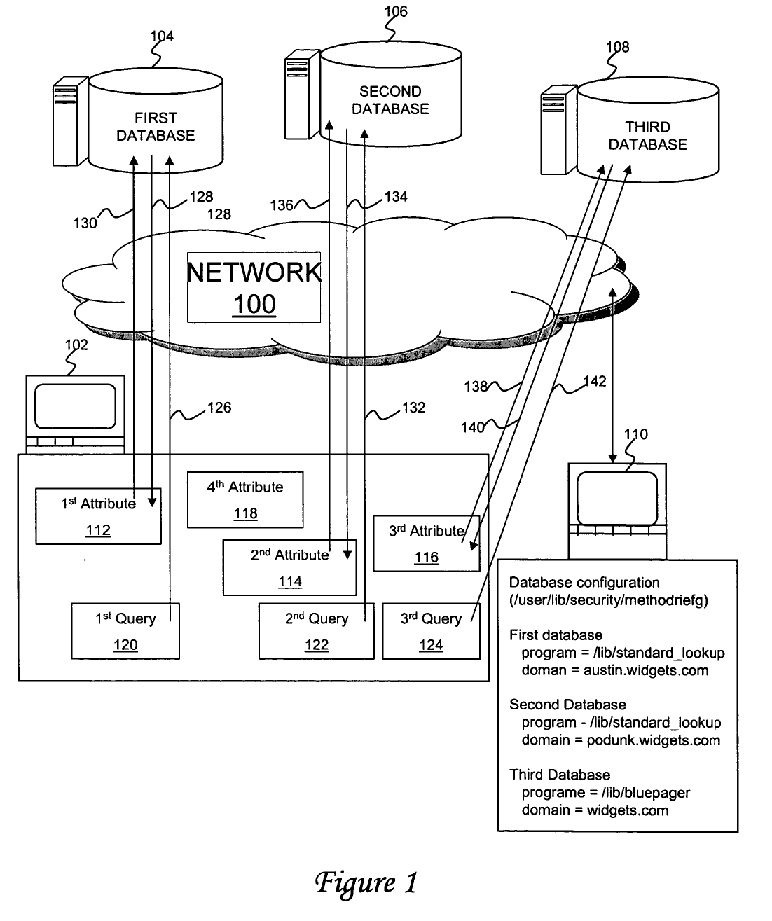

With reference now to the figures and in particular with reference to FIG. 1, there is depicted an exemplary network environment with which the present invention may be advantageously utilized. The illustrated network environment includes a local or wide area network 100, such as the Internet or another packetized digital network. A query client data processing system 102, a first database 104, a second database 106, a third database 108, and a configuration server 110 are attached to network 100.

Each of first database 104, second database 106, and third database 108 contains data stored in electronic records, though the contents of an individual record may be spread among more than one of first database 104, second database 106, and third database 108. Query client data processing system 102 performs functions related to access, distribution and modification of electronic records, located on first database 104, second database 106, and third database 108. Query client data processing system 102 uses data stored by configuration server 110 to communicate with first database 104, second database 106, and third database 108 over network 100.

For the purpose of simplifying discussion of the invention itself, many details of query client data processing system 102, which details are well within that which is known to one of skill in the relevant data processing arts, have been omitted from the discussion of the present invention. The operations of query client data processing system 102 with respect to first database 104, second database 106, and third database 108 may be implemented with conventional or later-developed hardware or software.

The functions of query client data processing system 102 include, but are not limited to access to, distribution of and modification of electronic records, which records are built from attributes. In the example shown with respect to query client data processing system 102, query client data processing system 102 operates under instructions to assemble, for a given record or group of records, a first attribute 112, a second attribute 114, a third attribute 116, and a fourth attribute 118. For some of first attribute 112, second attribute 114, third attribute 116, and fourth attribute 118, query client data processing system 102 will have access to stored information, hereafter called assignments, sometimes internally stored and sometimes stored on configuration server 110, relating to the location from which some attributes can be retrieved, but may have no such assignment information relative to the locations from which other attributes may be retrieved.

First attribute 112, second attribute 114, third attribute 116, and fourth attribute 118 are retrieved by query client data processing system 102 through the sending of queries to first database 104, second database 106, and third database 108. For purposes of explanation, the example illustrated with respect to FIG. 1 operates on the assumption that query client data processing system 102 will have access to stored information relating to the location among first database 104, second database 106, and third database 108 at which first attribute 112 and third attribute 116 can be accessed. With respect to second attribute 114 and fourth attribute 118, the example illustrated with respect to FIG. 1 assumes that no location data is available to query client data processing system 102 that would be helpful in ascertaining the location of the attributes among first database 104, second database 106, and third database 108 of second attribute 114 and fourth attribute 118.

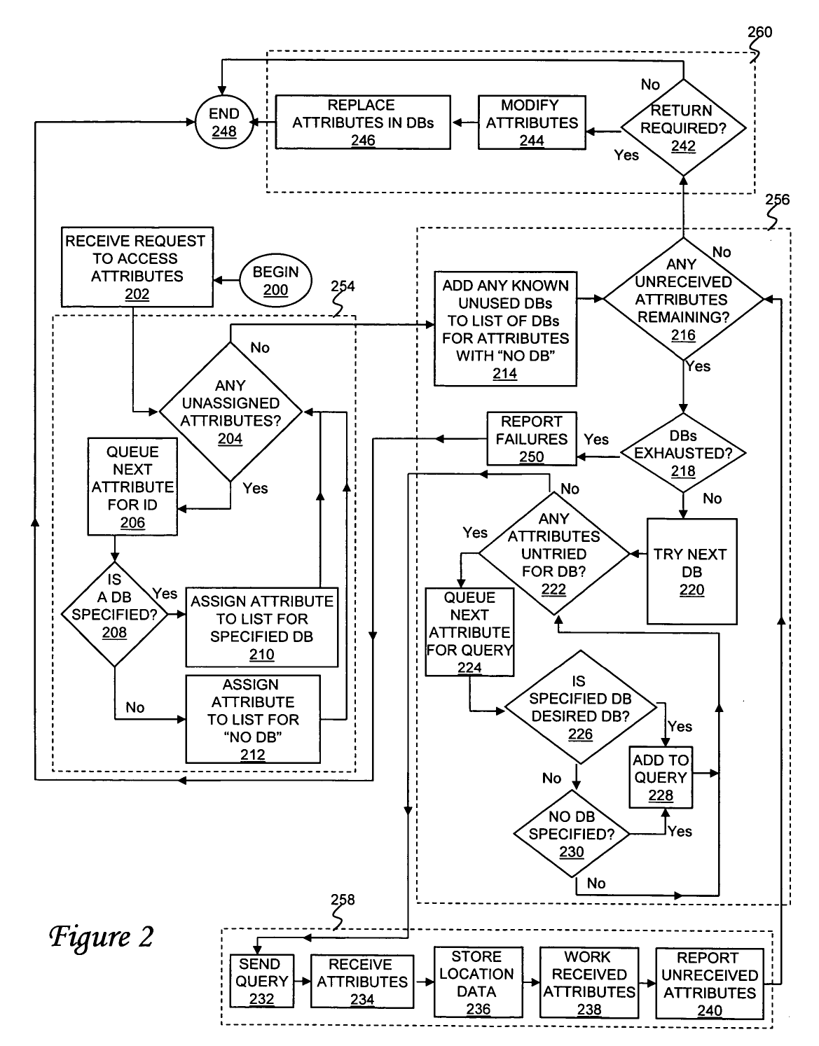

The process for managing database records with attributes located in multiple registries in accordance with a preferred embodiment of the present invention, described in detail below with respect to FIG. 2, will result in the sending and receiving of several messages. As examples of these messages, first query message 126 contains first query 120, directed to first database 104, and includes a request for first attribute 112, second attribute 114 and fourth attribute 118. No request for third attribute 116 is included in first query 120, because location data is available to query client data processing system 102 that indicates the presence of third attribute 116 on third database 108. The response to first query 120 arrives at query client data processing system 102 in the form of first attribute message 128, which contains first attribute 112 and data acknowledging the absence from first database 104 of second attribute 114 and fourth attribute 118. Query client data processing system 102 returns first attribute 112 to first database 104 by means of first attribute return message 130.

Similarly, second query message 132 contains second query 122, directed to second database 106, and includes a request for second attribute 114 and fourth attribute 118. No request for third attribute 116 is included in second query 122, because location data is available to query client data processing system 102 that indicates the presence of third attribute 116 on third database 108. Likewise, no request for first attribute 112 is included in second query 122, because query client data processing system 102 received first attribute 112 in first attribute message 128. The response to second query 122 arrives at query client data processing system 102 in the form of second attribute message 134, which contains second attribute 114 and data acknowledging the absence from second database 106 of fourth attribute 118. Query client data processing system 102 returns second attribute 114 to second database 106 by means of second attribute return message 136.

As a final example, third query message 142 contains third query 124, directed to third database 108, and includes a request for third attribute 116 and fourth attribute 118. No request for first attribute 112 or second attribute 114 is included in third query 124, because query client data processing system 102 received first attribute 112 in first attribute message 128 and received second attribute 114 in second attribute message 134. The response to third query 124 arrives at query client data processing system 102 in the form of third attribute message 140, which contains third attribute 116 and data acknowledging the absence from third database 108 of fourth attribute 118. Query client data processing system 102 returns third attribute 116 to third database 108 by means of third attribute return message 138.

With reference now to FIG. 2, there is depicted a high-level logical flowchart of a process for managing database records with attributes located in multiple registries in accordance with a preferred embodiment of the present invention. While the process of FIG. 2 has been illustrated in a simplified embodiment as a logical flowchart, wherein single operations are explained sequentially for the purpose of explanatory clarity, one skilled in the art will quickly recognize that the process depicted in FIG. 2 can be separated into a group of interacting processes, operating as modules or program objects in parallel processes and interacting with one another.

Among these subprocesses, which can be described as modules and whose parts will be explained in greater detail below, assignment module 254 comprises steps 204-212. Assignment module 254 performs steps related to identifying whether, for each requested attribute, a known database location exists, such as first database 104 as a location for first attribute 112. As will be detailed below, with respect to the example portrayed in FIG. 1, the steps of assignment module 254 include analysis by query client data processing system 102 as to which database can appropriately provide a given attribute, and the assignment of the attribute to a list, which is then used by query client data processing system 102 in query preparation module 256.

Query preparation module 256 comprises steps 214-230 and step 250. Query preparation module 256 prepares queries for query client data processing system 102 to send to databases across network 100. The third module, query communication module 258, includes steps 232-240 and sends queries to databases across network 100. Return module 260 returns query data to an appropriate database after it has been modified, and comprises steps 242-246.

The process of FIG. 2 begins at step 200, which depicts query client data processing system 102 beginning the process of accessing, distributing and modifying a record in a database that is distributed across multiple data processing systems connected to a network. Step 200 typically involves activation of a query process on query client data processing system 102, and activation may come from a user or an automated query. The process then proceeds to step 202, which illustrates query client data processing system 102 receiving a request to access or modify record attributes for one or more records located on remote databases. As depicted with respect to the example in FIG. 1, query client data processing system 102 processes a query for four attributes of one or more records. The requested attributes are first attribute 112, second attribute 114, third attribute 116, and fourth attribute 118.

The process of FIG. 2 next moves to step 204, which is part of an assignment subprocess, previously identified as assignment module 254. Step 204 depicts query client data processing system 102 determining whether any requested attributes (e.g., first attribute 112, second attribute 114, third attribute 116, and fourth attribute 118) remain in an ‘unassigned’ condition. For purposes of the discussion with respect to FIG. 2 in light of the example described with respect to FIG. 1, an unassigned condition exists whenever, with respect to one of first attribute 112, second attribute 114, third attribute 116, and fourth attribute 118, query client data processing system 102 does not possess information as to the location among first database 104, second database 106 and third database 108 on which the needed attribute is stored. If the location of all desired attributes is known, then the process of FIG. 2 moves to step 214 in query formation module 256, which is described in detail below.

If, however, as in the example portrayed in FIG. 1, there exist attributes in an unassigned condition, for which location data is not available on query client data processing system 102, then the process of FIG. 2 next proceeds to step 206, which illustrates query client data processing system 102 queuing a next attribute for identification of its location. The process then moves to step 208, which illustrates query client data processing system 102 determining whether a database from among those to which query client data processing system 102 can send queries (e.g., first database 104, second database 106 and third database 108) is assigned to provide the attribute in question. The determination as to whether a database among those to which query client data processing system 102 can send queries is assigned to provide the attribute in question can be made from data received in a request to access attributes in step 202, from data stored on query client data processing system 102 or from data stored by other sources.

If a database is specified for the attribute in question, the process then moves to step 210 which depicts query client data processing system 102 assigning the attribute in question to a location list for the specified database. With respect to the example portrayed in FIG. 1, because the location of first attribute 112 on first database 104 is known, query client data processing system 102 assigns first attribute 112 to the list of attributes to be queried from first database 104. Similarly, because the location of third attribute 116 on third database 108 is known, query client data processing system 102 assigns third attribute 116 to the list of attributes to be queried from third database 108.

In step 208, if no location data is available for first attribute 112, then the process proceeds to step 212, which depicts query client data processing system 102 assigning an attribute to the list of attributes for which no database is known. In the example depicted in FIG. 1, database locations are assigned and known for first attribute 112 and third attribute 116, which would be assigned to query lists for their respective first database 104 and third database 108. However, no location data is available for second attribute 114 and fourth attribute 118. Second attribute 114 and fourth attribute 118 would be assigned to the query list for those attributes for which no database location data is known. After the completion of step 210 or the completion of step 212, the process returns to step 204.

If, in step 204, no attributes remain which have not been assigned to the lists for a particular database or to the list for which no database location is known, the process then enters query preparation module 256 as the process moves to step 214. Step 214 illustrates query client data processing system 102 adding any known unused database location data to the list of databases which will be queried with respect to attributes for which no location database is known. This data will typically be available from configuration server 110.

The process of FIG. 2 then proceeds to step 216, which depicts query client data processing system 102 determining whether any unreceived attributes remain. If no unreceived attributes remain, then the process leaves query preparation module 256 and enters return module 260 as the process moves to step 242, which will be described in detail below.

If any unreceived attributes remain, then the process of FIG. 2 proceeds to step 218, which illustrates query client data processing system 102 determining whether it has exhausted all of the possible databases that are available to receive queries for any unreceived attributes. The databases, which are available to receive queries for unreceived attributes, will include those databases referenced in information stored on query client data processing system 102, those databases referenced in information received from configuration server 110, and those databases referenced in any information received in response to queries to previously queried databases. An individual database is exhausted after a query has been sent to it.

If the available databases have not been exhausted, then the process moves to step 220, which depicts query client data processing system 102 queuing the next attribute for possible addition to the query, which is being prepared for transmission to the current database selected in step 220. The process then proceeds to step 222, which depicts query client data processing system 102 determining whether any of the desired attributes remain untried for the current database selected in step 220. This step involves determining whether each of the unreceived attributes has been tried for the current database selected in step 220.

If, in step 222, untried attributes remain, then the process of the preferred embodiment will move to step 224, which illustrates the query client data processing system 102 designating the next attribute for possible addition to the query being sent the current database selected in step 220. The process then proceeds to step 226, which depicts query client data processing system 102 determining whether the database specified in step 224 to receive the query currently being formed is the desired database that is assigned as containing the attribute under consideration. To determine if the database specified in step 224 to receive the query currently being formed in query formation module 256 is the desired database that is assigned as containing the attribute under consideration, query client data processing system 102 refers to the list prepared in assignment module 254 for the current database selected in step 220, and ascertains whether the current attribute contained is identified on the list generated in assignment module 254. If the specified database being tried is the desired database, which is known to contain the required attribute, then the process moves to step 228, which depicts query client data processing system adding the current attribute to the query for the current database.

If in step 226, the specified database is not the desired database, the process proceeds to step 230, which illustrates query client data processing system determining whether any database is specified with respect to the attribute under consideration. Query client data processing system 102 determines that no database is specified for an attribute by searching for the current attribute in the list prepared by assignment module 254, containing those attributes for which no database was specified. If no database is specified for the attribute under consideration, the process moves to step 228, in which query client data processing system 102 adds the attribute under consideration, for which no location data is available, to the query being prepared for the current database selected in step 220.

If a specified database is available but the current database is not the specified database, then the process returns to step 222, which is discussed above. Returning to step 222, if no attributes remain untried for the current database, then the process moves to step 232, which depicts sending a query to the current database.

In the example illustrated with respect to FIG. 1, three queries are presented. First query 120 is a query for first attribute 112, fourth attribute 118, and second attribute 114. Second query 122 is a query requesting second attribute 114 and fourth attribute 118. Third query 124 requests third attribute 116 and fourth attribute 118.

Returning to FIG. 2, the process of FIG. 2 next passes to step 234, which illustrates client data processing 102 receiving attributes. As noted above, sending query 120 as a first query message 126 would result in the return of attribute 112 in first attribute message 128. Similarly, sending second query 122 as second query message 132 would result in receipt of second attribute 114 as second attribute message 134, and sending third query 124 as third query message 142 would result in receipt of third attribute 116 as third attribute message 140. The process then proceeds to step 236, wherein query client data processing system 102 stores location data for the attributes that it has received in step 234. The process next moves to step 238, which depicts query client data processing system performing operations on or with the received attributes. Operations performed on the received attributes will vary from embodiment to embodiment, and can include any operation that would be performed in the conventional The process of FIG. 2 next proceeds to step 240, which depicts the recording on un-received attributes, and is then followed by a return to step 216, which is discussed above.

Returning to step 216, if query client data processing system determines that no unreceived attributes remain, the process next moves to step 242, which depicts query client data processing system 102 determining whether a return of any attributes is required. If the return of attributes is required, the process of FIG. 2 then proceeds to step 244, which depicts modification of attributes which require modification. The process then moves to step 246, which depicts replacing the modified attributes in their original databases by reference to the stored location information. The process then ends at step 248. If, in step 242, query client data processing system 102 determines that no attributes require modification, then the process of FIG. 2 next moves to step 248, where it ends.

Returning to step 218, if, in step 218 query client data processing system 102 determines that all of its available databases have been queried and there are attributes that have not been found in any database, then the process moves to step 250, which illustrates query client data processing system reporting failures and ends at step 248.

As has been described, the present invention provides a system, method and computer program product for accessing, distributing and/or modifying a record in a database that is distributed across multiple data processing systems connected to a network. The present invention provides facilities for sending a query from a local query client data processing system to a remote database, wherein that query is composed of requests for attributes known to be stored on the database and attributes whose location is unknown. Once an attribute is received from a remote database, the present invention provides facilities for recording the location of the attribute on the remote database, and for modifying the attribute before returning it to the remote database on the basis of the stored location information. The present invention improves interaction with databases by providing an orderly and methodical system for dealing with attributes distributed across multiple databases.

While the invention has been particularly shown as described with reference to a preferred embodiment, it will be understood by those skilled in the art that various changes in form and detail may be made therein without departing from the spirit and scope of the invention. It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communications links.

What is claimed is:

1. A method of accessing a distributed database, comprising:
identifying one or more attributes of a record to be accessed from one or more of a plurality of distributed databases, wherein a first attribute among said one or more attributes resides in an unknown database among said plurality of databases and it is known that a second attribute resides in a particular database among said plurality of databases;
forming a query, which query includes a request for said first attribute and a request for said second attribute;
sending said query to said particular database among said plurality of distributed databases;
receiving a positive response to said query indicating that said particular database contains said first attribute for said record;
in response to receiving said positive response, storing an identifier of said particular database in association with said first attribute; and
accessing said first attribute and said second attribute of said record in said particular database.

2. The method of claim 1, wherein accessing said first attribute and said second attribute of said record in said particular database further comprises receiving said selected attribute from said particular database.

3. The method of claim 1, wherein accessing said first attribute and said second attribute of said record in said particular database further comprises modifying said selected attribute within said particular database.

4. The method of claim 1, wherein storing an identifier of said particular database in association with said first attribute further comprises sending said identifier to a second database.

5. The method of claim 1, wherein:
identifying one or more attributes of a record to be accessed further comprises identifying a third attribute among said one or more attributes that resides in an unknown database among said plurality of databases;
forming a query further comprises forming a first query of said particular database, which includes a request for said first attribute, a request for said second attribute, and a request for said third attribute; and
said method further comprises sending to a second database among said plurality of distributed databases a second query, which includes a request for said third attribute and omits requests for said first and second attributes.

6. The method of claim 1, wherein storing an identifier of said particular database in association with said first attribute comprises storing said identifier of said particular database in association with said first attribute on a client.

7. The method of claim 1, further comprising logging one or more attributes for which a positive response was not received.

8. The method of claim 1, further comprising logging a failure to receive a positive response for said second attribute.

9. A system for accessing a distributed database, said system comprising:
means for identifying one or more attributes of a record to be accessed from one or more of a plurality of distributed databases, wherein a first attribute among said one or more attributes resides in an unknown database among said plurality of databases and it is known that a second attribute resides in a particular database among said plurality of databases;
means for forming a query, which query includes a request for said first attribute and a request for said second attribute;
means for sending said query to said particular database among said plurality of distributed databases;
means for receiving a positive response to said query indicating that said particular database contains said first attribute for said record;
means, in response to receiving said positive response, for storing an identifier of said particular database in association with said first attribute; and
means for accessing said first attribute and said second attribute of said record in said particular database.

10. The system of claim 9, wherein said means for accessing said first attribute and said second attribute of said record in said particular database further comprises means for receiving said selected attribute from said particular database.

11. The system of claim 9, wherein said means for accessing said first attribute and said second attribute of said record in said particular database further comprises means for modifying said selected attribute within said particular database.

12. The system of claim 9, wherein said means for storing an identifier of said particular database in association with said first attribute further comprises means for sending said identifier to a second database.

13. The system of claim 9, wherein:
said means for identifying one or more attributes of a record to be accessed further comprises means for identifying a third attribute among said one or more attributes that resides in an unknown database among said plurality of databases;
said means for forming a query further comprises means for forming a first query of said particular database, which includes a request for said first attribute, a request for said second attribute, and a request for said third attribute; and
said system further comprises means for sending to a second database among said plurality of distributed databases a second query, which includes a request for said third attribute and omits requests for said first and second attributes.

14. The system of claim 9, wherein said means for storing an identifier of said particular database in association with said first attribute comprises means for storing said identifier of said particular database in association with said first attribute on a client.

15. The system of claim 9, further comprising means for recording one or more attributes for which a positive response was not received.

16. The system of claim 9, further comprising means for logging a failure to receive a positive response for said second attribute.

17. A computer program product in a computer-readable medium for accessing a distributed database, said computer program product comprising:
a computer-readable medium;
instructions on the computer-readable medium for identifying one or more attributes of a record to be accessed from one or more of a plurality of distributed databases, wherein a first attribute among said one or more attributes resides in an unknown database among said plurality of databases and it is known that a second attribute resides in a particular database among said plurality of databases;
instructions on the computer-readable medium for forming a query, which query includes a request for said first attribute and a request for said second attribute;
instructions on the computer-readable medium for sending said query to said particular database among said plurality of distributed databases;
instructions on the computer-readable medium for receiving a positive response to said query indicating that said particular database contains said first attribute for said record;
instructions on the computer-readable medium for, in response to receiving said positive response, storing an identifier of said particular database in association with said first attribute; and
instructions on the computer-readable medium for accessing said first attribute and said second attribute of said record in said particular database.

18. The computer program product of claim 17, wherein said instructions on the computer-readable medium for accessing said first attribute and said second attribute of said record in said particular database further comprises instructions on the computer-readable medium for receiving said selected attribute from said particular database.

19. The computer program product of claim 17, wherein said instructions on the computer-readable medium for accessing said first attribute and said second attribute of said record in said particular database further comprise instructions on the computer-readable medium for modifying said selected attribute within said particular database.

20. The computer program product of claim 17, wherein said instructions on the computer-readable medium for storing an identifier of said particular database in association with said first attribute further comprises instructions on the computer-readable medium for sending said identifier to a second database.

21. The computer program product of claim 17, wherein:
said instructions on the computer-readable medium for identifying one or more attributes of a record to be accessed further comprises identifying a third attribute among said one or more attributes that resides in an unknown database among said plurality of databases;
said instructions on the computer-readable medium for forming a query further comprises forming a first query of said particular database, which includes a request for said first attribute, a request for said second attribute, and a request for said third attribute; and
said computer program product further comprises instructions on the computer-readable medium for sending to a second database among said plurality of distributed databases a second query, which includes a request for said third attribute and omits requests for said first and second attributes.

22. The computer program product of claim 17, wherein said instructions on the computer-readable medium for storing an identifier of said particular database in association with said first attribute comprises instructions on the computer-readable medium for storing said identifier of said particular database in association with said first attribute on a client.

23. The computer program product of claim 17, further comprising instructions on the computer-readable medium for logging one or more attributes for which a positive response was not received.

24. The computer program product of claim 17, further comprising instructions on the computer-readable medium for logging a failure to receive a positive response for said second attribute.
